(19) United States
(12) Patent Application Publication
(10) Pub. No.: US 2013/0050776 A1
(43) Pub. Date: Feb. 28, 2013

(54) ELECTRONIC READING DEVICE HAVING WINDOWS SYSTEM ON PAPER AND CAPABLE OF READING MULTIPLE DATA

(71) Applicant: Yim wai Yau, Hong Kong (CN)

(72) Inventor: Yim wai Yau, Hong Kong (CN)

(21) Appl. No.: 13/583,224

(22) PCT Filed: Mar. 8, 2011
(86) PCT No.: PCT/CN2011/071595

§ 371 Date: Nov. 15, 2012

(30) Foreign Application Priority Data
Mar. 8, 2010 (CN) 201020125862.4
Mar. 23, 2010 (CN) 201020140338.4
Mar. 23, 2010 (CN) 201020168752.6

(51) Int. Cl. H04N 1/04

(52) U.S. Cl. 358/474

(57) ABSTRACT

The invention relates to an electronic reading device that can be used in combination with print media, and more particularly, to an electronic reading device having an on-paper window system and being capable of reading various data. The electronic reading device includes an electronic coordinate device, a circuit substrate for a central processor, which is provided with a storage, and multiple sets of optoelectronic devices and is configured to read various data from media, having information messages, and an electronic coordinate circuit, respectively. The data can be transmitted to the circuit substrate for the central processor and then processed into combined data of electronic files such that related reference can be readily searched for and read using a connected electronic reading product.

### A) FIELD OF THE DISCLOSURE

The invention relates to an electronic reading device that can be used in combination with traditional print media, and more particularly, to an electronic reading device having an on-paper window system and being capable of reading various data. The electronic reading device includes an electronic coordinate device, a circuit substrate for a central processor, which is provided with a storage, and multiple sets of optoelectronic devices. The electronic reading device can read various data from media, having information messages, and an electronic coordinate circuit, respectively. The data can be transmitted to the circuit substrate for the central processor and then processed into combined data of electronic files. Thereby, associated information can be readily searched for and read using a connected electronic reading product.

### B) BRIEF DESCRIPTION OF THE RELATED ART

People cannot live without words, pictures, sounds and videos for recordation and dissemination of information, but expression of traditional media, such as paper newspapers, far cannot meet actual human needs. Humans desire for traditional paper newspapers having contents in combination with background texts, pictures, sounds and videos.

With rapid development and popularization of digital communication and network technology, people can get more and more diverse knowledge and information channels. A variety of e-books, learning machines and PDAs having computer functions have been developed.

Many programs and products, i.e. electronic reading devices realizing paperless environments, have been developed for years. The promotion for paperless environments has been proved to be ineffective for long years. Accordingly, experts propose a new concept of “e-paper combination” that paper reading and electronic reading are coexistence.

Combination of paper publications and electronic digital technologies is necessary for people and is a trend for development of culture industries. Accordingly, in many years, researchers around the world tirelessly pursued technological breakthroughs, but have no effective solution to complementary use of print media combined with an electronic reading device. Even though numerous electronic reading products on market solve the above problems from a certain aspect, but they are limited to be used in a specific scope.

U.S. Pat. Nos. 5,686,705 and 5,877,458 issued in March 1999 disclose a simple interactive reading and learning system for paper published books. The electronic coordinate technology, in accordance with these patents, is based on a charge-transfer sensing technology for positioning and identifying paper published books, which has the following drawbacks:
1. Only planar positions of a page when being touched can be determined, but which page is selected cannot be determined.
2. A signal emitted from an electric pen is weakened when passing through a book having increased thickness. Even the signal emitted from the electric pen could not pass through the books, and thus misidentification or non-identification could be resulted in.

Objectively speaking, the electronic coordinate technology is just a single coordinate-position identification technology that cannot determine which page of papers is selected. The single coordinate-position identification technology has constraints that cannot be broken through so far. In practice, a relevant product operates with an additional function of page selection, besides its regular circuit design.

With rapid development of the electronic digital technologies and the needs of the market, researchers developed a new two-dimensional-code technology on the basis of original barcodes, i.e. one-dimensional codes, in photoelectric reading technologies.

The two-dimensional codes are arranged with multiple minute symbol units. The minute symbol units are so minute as to be ignored in vision and are printed using a fluorescent ink having optical response to an infrared ray from an infrared emitter. In application, the two-dimensional codes are inserted beside the texts and inserted illustrations such that the texts and inserted illustrations can be positioned and identified by a photoelectric device. In fact, the inserted two-dimensional codes are identified. A response image of the minute symbol units can be captured by an image capturing device. Determined data can be transmitted from a photoelectric conversion circuit to a circuit substrate for a central processor for processing the determined data into digital data. Thus, the purpose of “e-paper combination” can be achieved.

In theory, compared with the electronic coordinate technology a two-dimensional-code technology has no limit to the thickness and the number of pages of the book, but its identification relies entirely on the two-dimensional codes next to the texts and inserted illustrations. Thus, code sources of the two-dimensional codes are the key to effective development of the technology. An electronic reading product employing the two-dimensional codes has the following shortcomings:
1. The two-dimensional code is composed of a dot matrix including multiple dots, known as a basic unit of a two-dimensional code. Capture for the basic unit of the two-dimensional code is determined according to DPI of a photoelectric device and a size of an imaging device and is affected by conditions of the photoelectric device. The number of the code sources of the two-dimensional codes is severely limited, and this results in different publications sharing the same two-dimensional codes. Accordingly, reading contents could appear mistaken identity.
2. An identification technology for the two-dimensional codes relies entirely on the two-dimensional codes next to the texts and illustrations. The technology must be applied by the relevant professionals editing, proofing and processing for printing. The two-dimensional codes are “dead” codes with respect to a user, i.e. the user can only receive, and passively use them without any change.

Therefore, products using the two-dimensional code have constraint conditions, especially code sources. Researchers are still unable to break through the limitations of passive use. Market application is focused on low-requirement children's publications.

The skilled in the art propose RFID programs to achieve a new “e-paper combination” effect. In theory, it is possibly feasible but does not meet requirements of people's actual use.

An RFID technology is a non-contact automatic-identification technology that uses an RF signal to automatically identify a target and obtain relevant data, but has conditions that the target marked on an object should have a tag with an independent electronic code. Thereby, information of the tag can be read by a supporting card reader or sometimes can be written. When entering a magnetic field, the tag can receive the RF signal emitted by the reader and then the tag can use an energy obtained from an induced current to send product information stored in a chip or actively to send a signal at a specific frequency. The product information or signal, after being read and decoded by the reader, can be sent to a central information system for data processing. Therefore, the contents needing to be established must be provided with tags, and data should correspond to respective forms of tags. All of the data corresponding to the tags are stored in a data storage.

However, in the actual reading, everyone has different methods and reading experience and countless explanations can be created with respect to a specific content of a book. It is quite a large, unpractical and cost and effect ineffective work that special equipment is used to establish independent tags for respective explanations for each content of the book. In fact, the RFID technology is not suitable for culture reading and based on the characteristics of the RFID technology, the RFID technology is mainly applied to a tracking system in logistics and supply managements and manufactures.

An optical-character-recognition (OCR) technology is used to voluntarily transform perused texts into an electronic text file. The OCR technology means a process that an electronic device, such as a scanner or digital camera, checks characters printed on a paper, determines their shapes via detection in dark and bright modes, and then transforms their shapes into computer texts using a character recognition process.

A lot of blind people around the world read relevant products using the technology. The process from images to outputs includes inputting images, preprocessing images, extracting text features, comparing, identifying, manually correcting misidentified words, the step of which is an insuperable difficulty for the blind, and finally outputting results. Due to lack of skill, relevant products cannot provide substantial help for the blind to read or touch words.

For the purpose that people, especially the underprivileged blind, can enjoy achievements of digital technologies, the applicant provides an effective solution to print reading combined with electronic reading and owns multiple patents for the technology. For example, patent application No. 200410079216.8, entitled as “multi-page foldable data book with PDA”, patent application No. 200510065313.6, entitled as “multifunctional covering device mountable onto PDA”, and patent application No. 200510088377.8, entitled as “braille-word writing device having information processing function” are owned.

Based on the conventional electronic-coordinate technology and the two-dimensional-code technology, an on-paper window system fully equivalent to usage conditions of the traditional technologies is created.
1. In accordance with the present invention, the amount of usable code sources, that is, the amount of multiplying the number of Y-coordinates by the number of X-coordinates is ten times or hundreds times more than that for the traditional two-dimensional codes.
2. In accordance with the present invention, the number of samples to be identified is less than that for the two-dimensional code. Thus, a structure of an invisible code is simpler than that of the two-dimensional code.

The on-paper window system provides solutions to technologies associated with traditional print reading and electronic reading. Print media on market are numerous, but more and more technologies are still to be provided to solve issues of code sources, costs, ease of use and so on such that use of traditional print reading combined with electronic reading can be effective and popular.

### SUMMARY OF THE DISCLOSURE

The invention provides a reading device capable of readily finding related reference.

In order to achieve the above purpose, the present invention proposes an electronic reading device having an on-paper window system and being capable of reading various data. The electronic reading device is composed of a reading panel and an electronic card reader, wherein the reading panel has a panel surface having media placed thereon, the electronic card reader includes an electronic coordinate device, a circuit substrate for a central processor, which is provided with a storage, and multiple sets of optoelectronic devices. The electronic coordinate device is composed of an electronic coordinate circuit and an electromagnetic-wave circuit configured to emit a signal with a fixed frequency. A first set of optoelectronic device and the electromagnetic-wave circuit compose an optoelectronic reading device. The optoelectronic reading device and a second set of optoelectronic device are configured to read various data from media, having information messages, and the electronic coordinate circuit, respectively. The data is configured to be transmitted to the circuit substrate for the central processor and then processed into combined data of electronic files. Thereby, related information, based on the combined data, can be readily searched for and read using a connected electronic reading product.

The reading panel, like a panel-shaped body, is divided into a reading and sensing area and non reading and sensing area, wherein the reading and sensing area corresponds to an effective sensing region of the electronic coordinate circuit in the reading panel. The electronic coordinate circuit is arranged with multiple electronic antenna-array type of circuit substrates having multiple electronic antenna loops alternately formed and overlain with each other or one another. The electronic antenna-array type of circuit substrates include a metal line, extending in a direction of X-axis, and another metal line, extending in a direction of Y-axis and across the direction of X-axis, that compose an array type of the antenna loops. The antenna-array type of circuit substrates are configured to sense the signal with the fixed frequency emitted from the electromagnetic-wave circuit and have contacts electrically connected to A/D devices of the circuit substrate for the central processor.

The reading panel, like a panel-shaped body, is composed of a left panel and a right panel. The left and right panels are configured to join with each other and move apart from a center line such that a clipping space can be kept between the left and right panels. The reading panel is divided into a reading and sensing area and non reading and sensing area, wherein the reading and sensing area corresponds to an effective sensing region of the electronic coordinate circuit in the reading panel. The left and right panels include electrically conductive devices, having opposite polarization, at neighboring sidewalls thereof and are electrically connected to the circuit substrate for the central processor. The electronic coordinate circuit is arranged with multiple electronic antenna-array type of circuit substrates having multiple electronic antenna loops alternately formed and overlain with each other or one another. The electronic antenna-array type of circuit substrates include a metal line, extending in a direction of X-axis, and another metal line, extending in a direction of Y-axis and across the direction of X-axis, that compose an array type of the antenna loops. The antenna-array type of circuit substrates are configured to sense the signal with the fixed frequency emitted from the electromagnetic-wave circuit and have contacts electrically connected to A/D devices of the circuit substrate for the central processor.

Each of the left and right panels includes at least a magnetic block at a corresponding neighboring sidewall thereof, wherein the magnetic blocks of the left and right panels have opposite polarization.

The media are divided into an information-sensing region and non information-sensing region corresponding to the reading and sensing area and non reading and sensing area of the reading panel, respectively.

The media are printed with invisible codes arranged with multiple minute symbol units printed using a fluorescent ink having optical response to an infrared ray from an infrared emitter.

The media having different information-sensing regions cannot be printed with the same invisible code. The non information-sensing region is printed with an invisible code. Each invisible code is arranged with multiple minute symbol units and is printed using a fluorescent ink having optical response to an infrared ray from an infrared emitter.

The first set of optoelectronic device includes an infrared emitter, an image capturing device and a photoelectric conversion circuit, wherein the image capturing device is configured to capture a response image of the invisible code, and the photoelectric conversion circuit is configured to transmit identified data to the circuit substrate for the central processor for processing the identified data. The optoelectronic reading device is arranged with a functional switch and an output circuit.

The second set of optoelectronic device including an infrared emitter, an image capturing device and a photoelectric conversion circuit is placed in an internally hollow body. A through window is set at a front end of the internally hollow body, wherein the infrared emitter is configured to emit an infrared ray to the outside via the through window, and the image capturing device is configured to capture an image via the through window. The image capturing device is configured to capture a response image of the invisible code. The photoelectric conversion circuit is configured to transmit determined data to the circuit substrate for the central processor for processing the determined data.

A small through hole is set at the non reading and sensing area of the reading panel and corresponds to the non information-sensing region of the media. The second set of optoelectronic device is placed in the reading panel and the through window at the second set of optoelectronic device is adjacent to and communicates with the small through hole at the reading panel.

On basis of an original on-paper window system, the electronic card reader employs multiple sets of optoelectronic devices. Thereby, the on-paper window system has powerful efficiency. Data read by the second set of optoelectronic device and data of the original on-paper window system can create geometric combinations for meeting demands of various print media on market. Thus, development of culture industries can be enhanced due to the improved technologic supports.

The accompanying drawings are included to provide a further understanding of the invention, and are incorporated as a part of this specification. The drawings illustrate embodiments of the invention and, together with the description, serve to explain the principles of the invention.

### BRIEF DESCRIPTION OF THE DRAWINGS

The drawings disclose illustrative embodiments of the present disclosure. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it refers to the same or like components or steps.

Aspects of the disclosure may be more fully understood from the following description when read together with the accompanying drawings, which are to be regarded as illustrative in nature, and not as limiting. The drawings are not necessarily to scale, emphasis instead being placed on the principles of the disclosure.

FIG. 1A is a schematically three-dimensional view showing left and right panels of a reading panel.

FIG. 1B is a schematically three-dimensional view showing the reading panel.

FIG. 1C is a schematic view showing an electronic coordinate circuit of the reading panel.

FIG. 2A is a schematically plane view showing the reading panel.

FIG. 2B is a side view of FIG. 2A.

FIG. 2C is a schematically plane view showing the reading panel has the left and right panels pushed to be open.

FIG. 2D is a side view of FIG. 2C.

FIG. 2E is a schematic view showing a profile structure of an electric paper book.

FIG. 2F is a schematic view showing an electronic reading device clips the electric paper book.

FIG. 2G is a schematic view showing the electronic reading device clips the electric paper book.

FIG. 3A is a schematic view showing a front page of a paper newspaper.

FIG. 3B is a schematic view showing a back page of the paper newspaper.

FIG. 3C is a schematic view showing an inner page of a paper magazine when opened.

FIG. 3D is a schematic view showing cover and bottom pages of the paper magazine when opened.

FIG. 4A is a schematic view showing a small hole at the reading panel.

FIG. 4B is a schematic view showing a second set of an optoelectronic device.

FIG. 4C is a schematic view of assembling the reading panel and the second set of optoelectronic device.

FIG. 5A is a schematic view showing an optoelectronic reading device connected with a physical line.

FIG. 5B is a schematic view showing an optoelectronic reading device wirelessly connected.

FIG. 5C is a reference circuit diagram showing an optoelectronic reading device.

FIG. 5D is a schematic view showing a principle of reading various data in accordance with the present invention.

FIG. 6A is a schematically dynamic view showing a rotary auxiliary panel.

FIG. 6B is a schematic view showing an effect of the rotary auxiliary panel.

FIG. 6C is a schematic view showing a retracting mode of a push-pull auxiliary panel.

FIG. 6D is a schematic view showing an effect of the push-pull auxiliary panel.

FIG. 7A is a schematically application view showing the electronic reading device wirelessly sends data.

FIG. 7B is a schematically design view showing the electronic reading device with an electronic reader.

FIG. 7C is a schematic view showing a physical wire connects the electronic reading device with the electronic reader.

FIG. 7D is a schematic view showing touch-selectable content in accordance with the present invention.

While certain embodiments are depicted in the drawings, one skilled in the art will appreciate that the embodiments depicted are illustrative and that variations of those shown, as well as other embodiments described herein, may be envisioned and practiced within the scope of the present disclosure.

### DETAILED DESCRIPTION OF THE INVENTION

Illustrative embodiments are now described. Other embodiments may be used in addition or instead. Details that may be apparent or unnecessary may be omitted to save space or for a more effective presentation. Conversely, some embodiments may be practiced without all of the details that are disclosed.

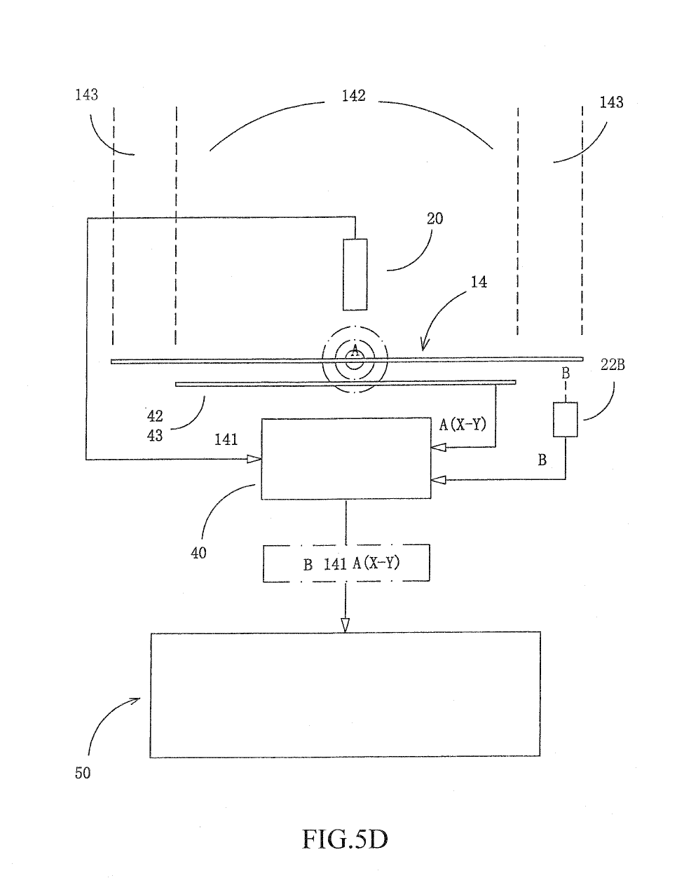

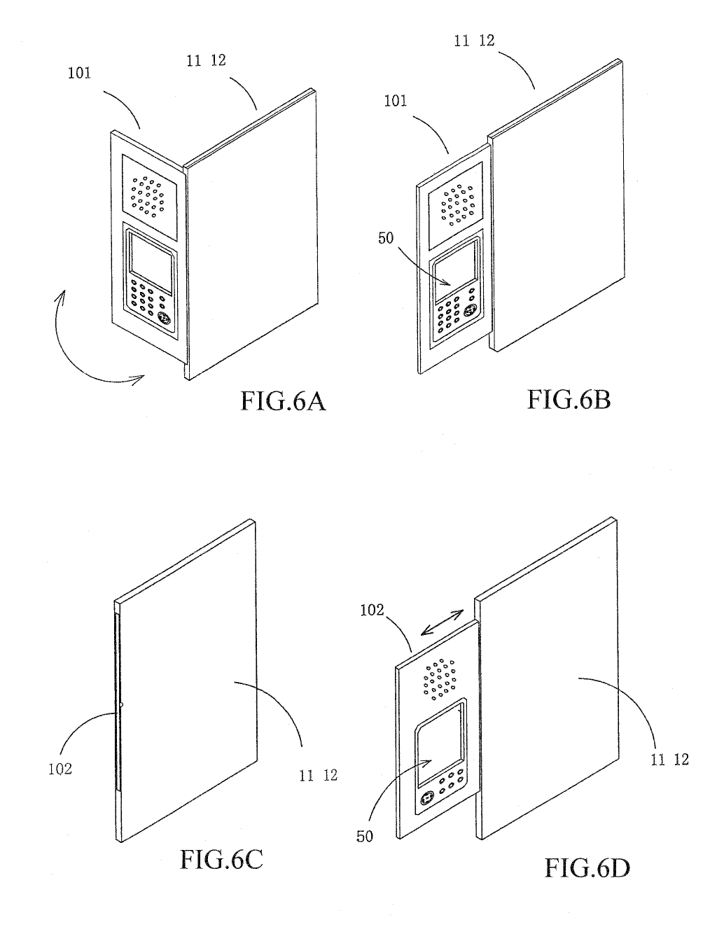

The present invention proposes an electronic reading device having an on-paper window system and being capable of reading various data. The electronic reading device is composed of a reading panel 100 and an electronic card reader, wherein the reading panel 100 has a panel surface having media 14, made of paper or other materials, placed thereon, the electronic card reader includes an electronic coordinate device, a circuit substrate 40 for a central processor, which is provided with a storage, and multiple sets of optoelectronic devices 22. The electronic coordinate device is composed of an electronic coordinate circuit and an electromagnetic-wave circuit 21 configured to emit a signal with a fixed frequency. A first set of optoelectronic device 22A and the electromagnetic-wave circuit 21 compose an optoelectronic reading device 20. FIG. 5C is a reference circuit diagram of the optoelectronic reading device. The optoelectronic reading device 20 and a second set of optoelectronic device 22B are configured to read various data from media, having information messages, and the electronic coordinate circuit, respectively. The data is configured to be transmitted to the circuit substrate 40 for the central processor and then processed into combined data of electronic files. Thereby, related information, based on the combined data, can be readily searched for and read using a connected electronic reading product, such as computer, handheld computer, handheld electronic reader, electronic learning machine, MP4, mobile phone, television or projector.

The reading panel 100, like a panel-shaped body, is divided into a reading and sensing area 1002 and non reading and sensing area 1003, wherein the reading and sensing area 1002 corresponds to an effective sensing region of the electronic coordinate circuit in the reading panel 100. The electronic coordinate circuit is arranged with multiple electronic antenna-array type of circuit substrates 42 and 43 having multiple electronic antenna loops alternately formed and overlain with each other or one another. The electronic antenna-array type of circuit substrates 42 and 43 include a metal line, extending in a direction of X-axis, and another metal line, extending in a direction of Y-axis and across the direction of X-axis, that compose an array type of the antenna loops. In accordance with the present invention, the electronic antenna-array type of circuit substrates 42 and 43 can be flexible electrically-conductive films or other materials. The electronic antenna-array type of circuit substrates 42 and 43 are configured to sense the signal with the fixed frequency emitted from the electromagnetic-wave circuit 21 and have contacts electrically connected to A/D devices of the circuit substrate 40 for the central processor.

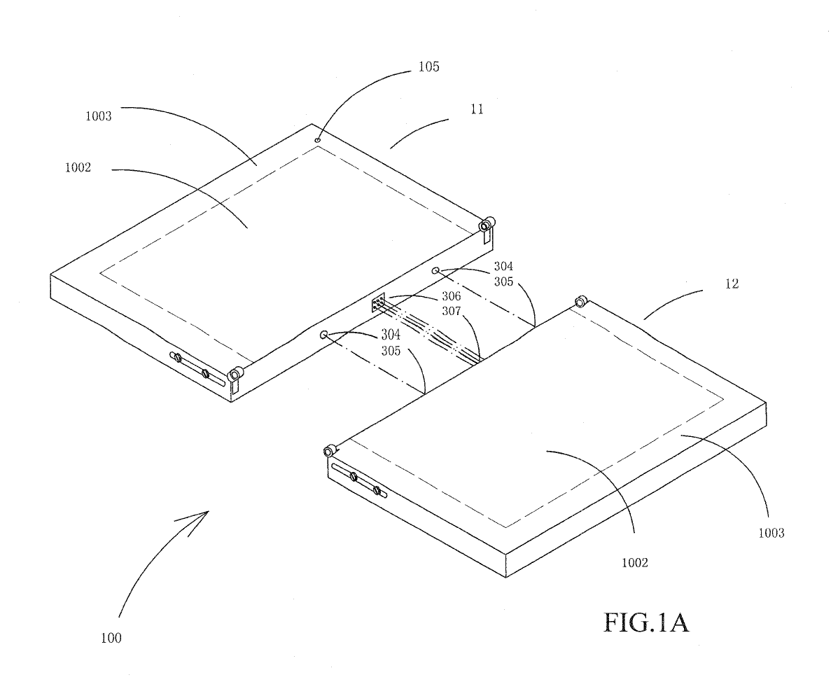

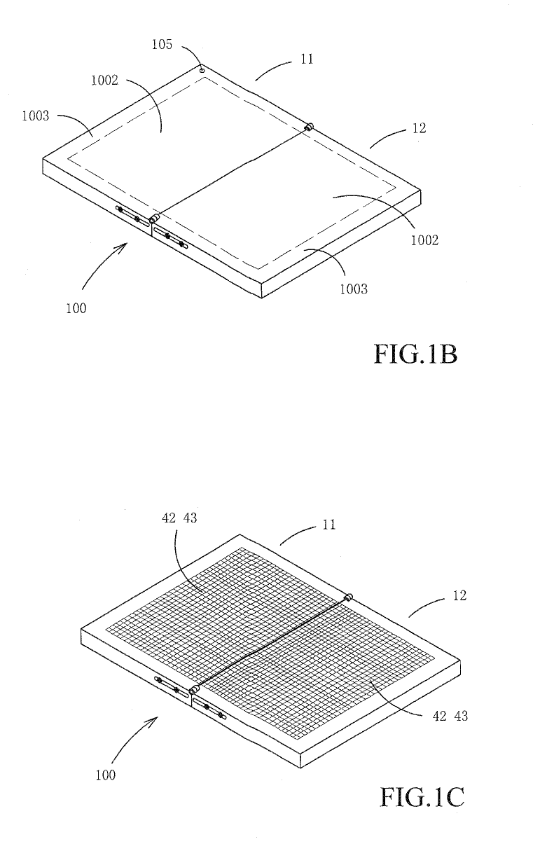

In order to meet various markets, another embodiment of the reading panel is seen in FIGS. 1A, 1B and 1C.

The reading panel 100, like a panel-shaped body, is composed of a left panel 11 and a right panel 12. The left and right panels 11 and 12 are configured to join with each other and move apart from a center line such that a clipping space 1001 can be kept between the left and right panels 11 and 12. The reading panel 100 is divided into a reading and sensing area 1002 and non reading and sensing area 1003, wherein the reading and sensing area 1002 corresponds to an effective sensing region of the electronic coordinate circuit in the reading panel 100. The left and right panels 11 and 12 include electrically conductive devices 306 and 307, having opposite polarization, at neighboring sidewalls thereof and are electrically connected to the circuit substrate 40 for the central processor. The electronic coordinate circuit is arranged with the electronic antenna-array type of circuit substrates 42 and 43 having multiple electronic antenna loops alternately formed and overlain with each other or one another. The electronic antenna-array type of circuit substrates include a metal line, extending in a direction of X-axis, and another metal line, extending in a direction of Y-axis and across the direction of X-axis, that compose an array type of the antenna loops. The antenna-array type of circuit substrates are configured to sense the signal with the fixed frequency emitted from the electromagnetic-wave circuit 21 and have contacts electrically connected to A/D devices of the circuit substrate 40 for the central processor.

The present invention can be used in combination with patent application No. 200820210181.0, entitled as electronic book provided with inner coordinate circuit device and print pages having data codes, owned by the applicant. As a result, a reading effect can be improved.

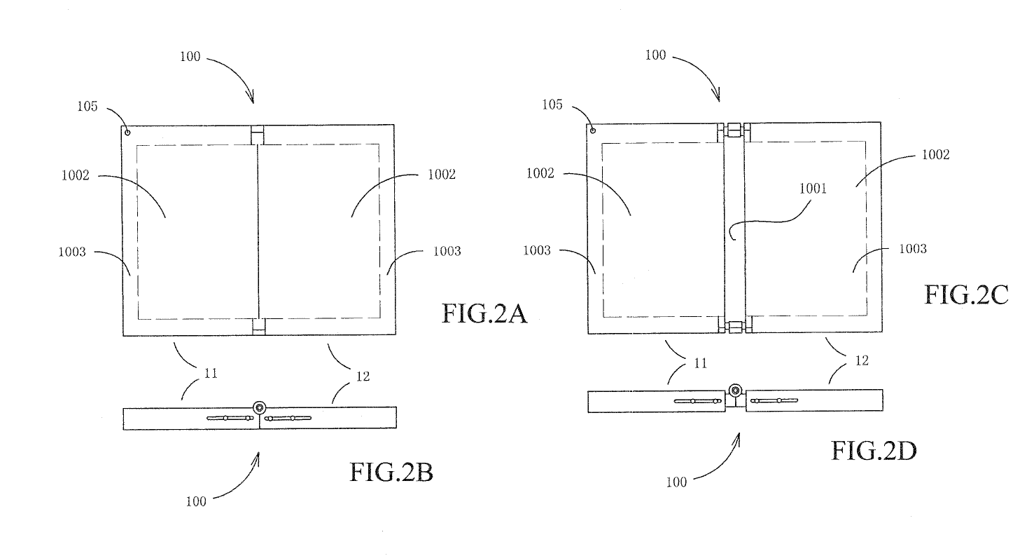

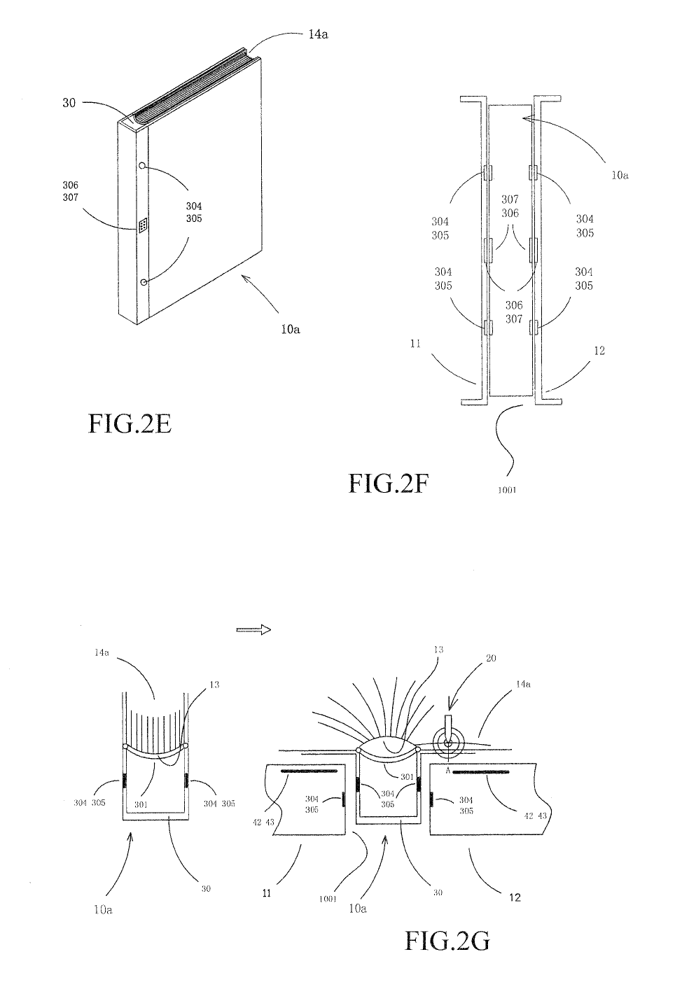

Referring to FIGS. 2E and 2G, a book 10a contains a cover joining a paper book, wherein a book ridge pedestal 30 is between joints of the cover and the paper book and joins the cover. The book ridge pedestal 30 movably contacts a contact surface 301 of a book ridge 13 of the paper book.

Referring to FIGS. 2C, 2D and 2F, the clipping space 1001 between the left and right panels 11 and 12 can accommodate the book ridge 13 of the book. Referring to FIG. 2G, in order to overcome an irregularly expanding status of a page 14a of the book 10a and have the page 14a naturally expand on a surface of the reading panel 100, related contents on the page 14a can be stably at relative positions to the electronic antenna-array type of circuit substrates 42 and 43 such that points of X-Y coordinates of the relative positions can be precisely determined.

At least a magnetic block 304 or 305 is set at each of two side surfaces of the book ridge pedestal 30 of the book 10a to be clipped, wherein the magnetic blocks 304 and 305 have opposite polarization. That is, each of the left and right panels 11 and 12 of the reading panel 100 includes at least a magnetic block 304 or 305 at a corresponding neighboring sidewall thereof, wherein the magnetic blocks 304 and 305 have opposite polarization. The magnetic blocks having properties of opposite attraction have the book 10a and the reading panel 100 tightly join together. The book ridge pedestal 30 of the book 10a to be clipped is arranged with electrically conductive devices 306 and 307 that can join electrically conductive devices arranged at the reading panel 100 such that an inner circuit of the reading panel 100 can be connected to an inner circuit of the book 10a and thus data in the reading panel 100 and book 10a can be shared to each other.

The book 10a to be clipped is arranged with an IC card containing a storage for providing various index data that are transmitted to the circuit substrate 40 for the central processor and processed into combined data for establishing electronic files. Thereby, preset related contents including text, pictures, sound, and video can be readily searched for through the connected electronic reader.

Data in various media or in different pages of the same medium can be read. The media 14 can be divided into an information-sensing region 142 and a non information-sensing region 143 corresponding to the reading and sensing area 1002 and non reading and sensing area 1003 of the reading panel 100, respectively.

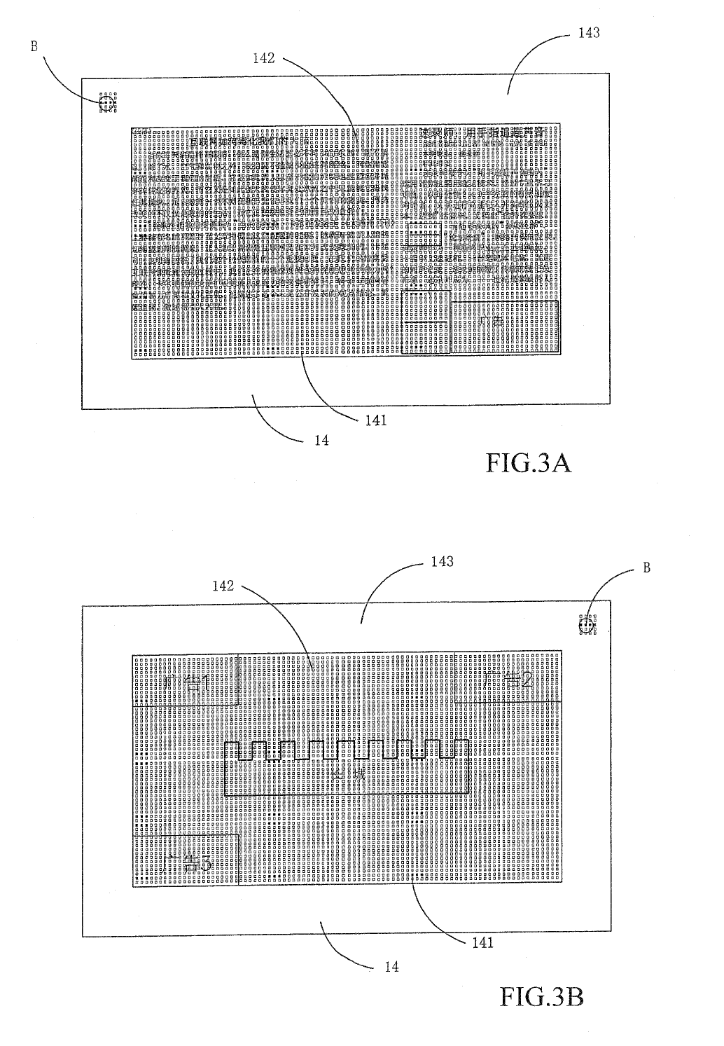

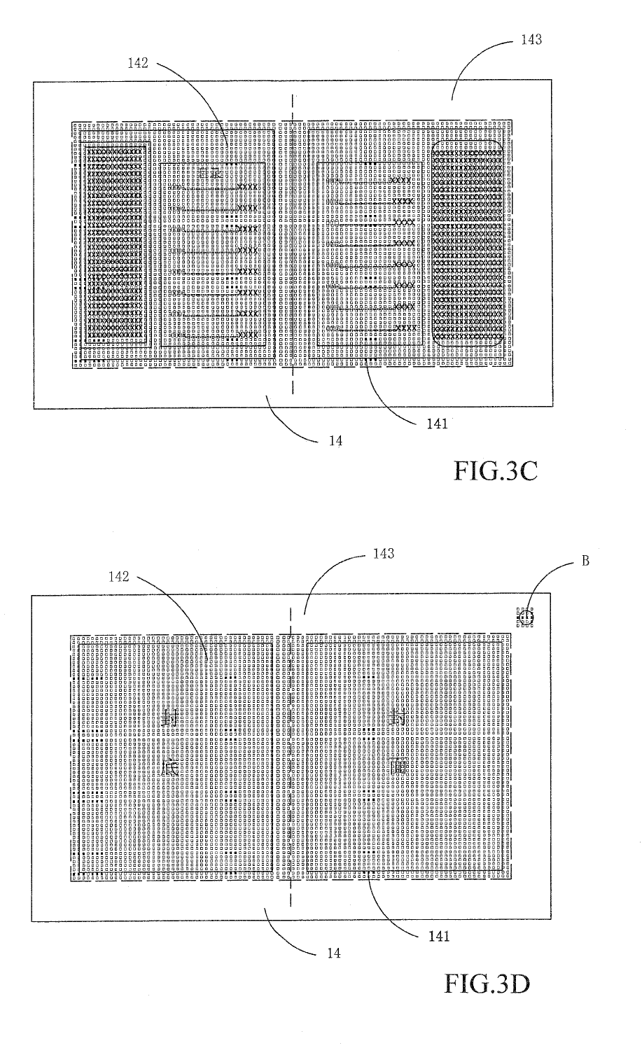

Referring to FIGS. 3A-3D, the media 14 are printed with invisible codes 141 arranged with multiple minute symbol units. The minute symbol units can be a single geometric picture, Arabic numerals, Roman numerals, English letters, text or various combinations of the above mentioned. The minute symbol units are so minute as to be ignored in vision and are printed using a fluorescent ink having optical response to an infrared ray from an infrared emitter. Text and pictures on a surface of the media can be printed using an ink not absorbing an infrared ray and can or cannot overlap the invisible codes 141. Because the minute symbol units are so minute as to be ignored in vision, no aesthetic impact would be caused on a print content.

The invisible codes 141 carry data of a page number that is an important feature for determining various media. In order to prevent reading contents from having mistaken identity due to duplication of code usage, the media 14 having different information-sensing regions 142 cannot be printed with the same invisible code 141. According to this specific demand, the media 14 can be printed with different invisible codes 141. The non information-sensing region 143 of the media 14 is printed with the invisible code 141. Each invisible code 141 is arranged with multiple minute symbol units printed using a fluorescent ink having optical response to an infrared ray from an infrared emitter.

Referring to FIGS. 5A and 5B, the first set of optoelectronic device 22A includes an infrared emitter 221, an image capturing device 222 and a photoelectric conversion circuit 223, wherein the image capturing device 222 is configured to capture a response image of the invisible code 141, and the photoelectric conversion circuit 223 is configured to transmit identified data to the circuit substrate 40 for the central processor for processing the identified data. Traditional electronic coordinate circuits have constraints that a touching and reading medium should be smaller than an area of the electronic antenna-array type of circuit substrates but needs be printed with pictures having large areas for enhancing an effect of reading contents.

The optoelectronic reading device 20 is arranged with a functional switch 241 and an output circuit 24. For meeting various reading needs, the functional switch 241 can be controlled to select a hybrid use of the optoelectronic devices 22 and electromagnetic-wave circuit 21, a single use of the optoelectronic devices 22 or a single use of the electromagnetic-wave circuit 21.

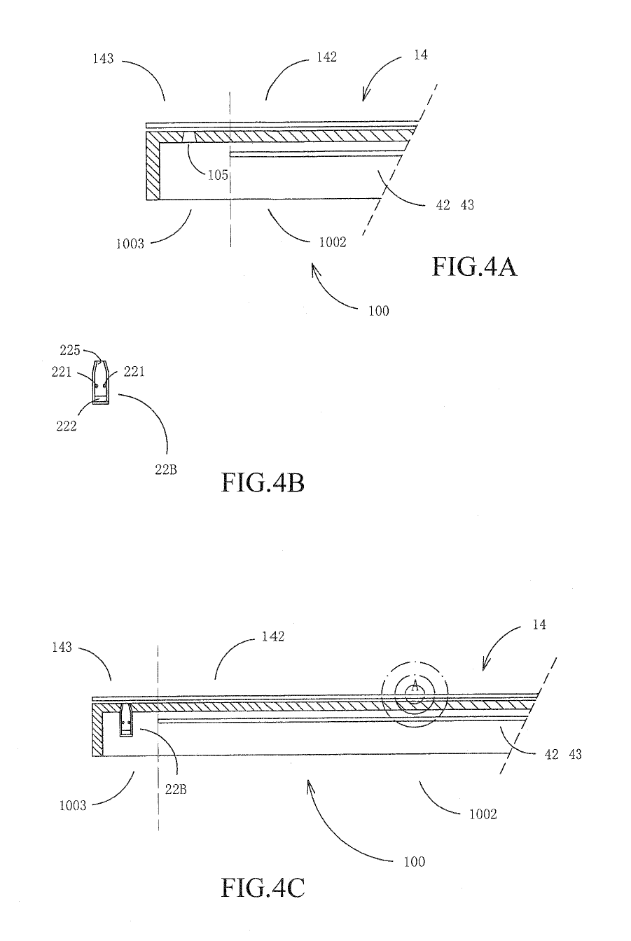

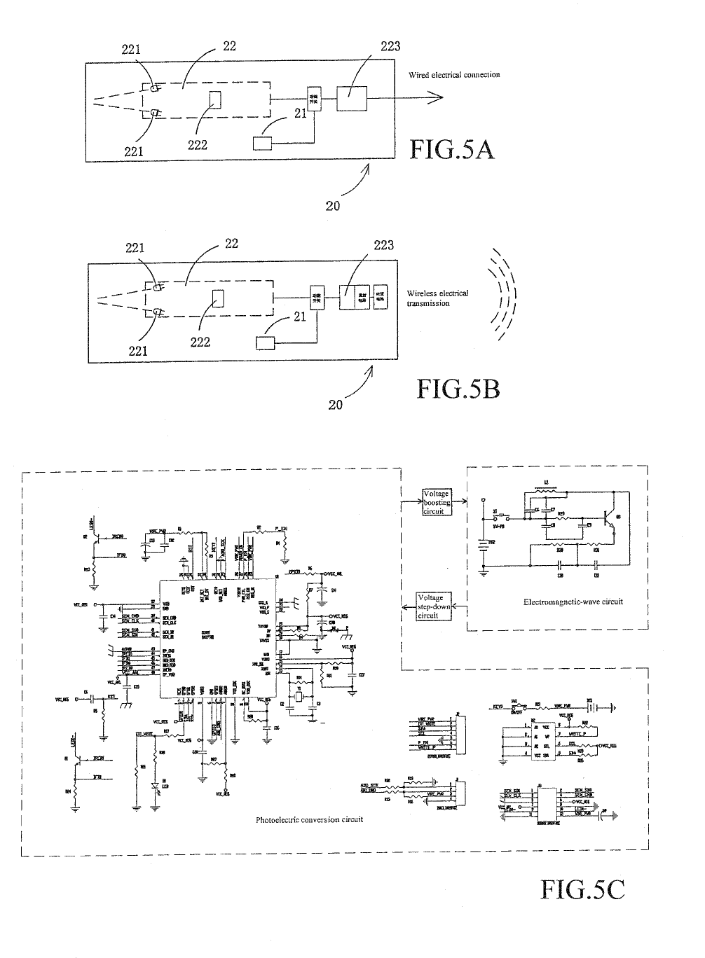

Referring to FIG. 4B, the second set of optoelectronic device 22B including an infrared emitter 221, an image capturing device 222 and a photoelectric conversion circuit 223 is placed in an internally hollow body. A through window 225 is set at a front end of the internally hollow body, wherein the infrared emitter 221 is configured to emit an infrared ray to the outside via the through window 225, and the image capturing device 222 is configured to capture an image via the through window 225. The image capturing device 222 is configured to capture a response image of the invisible code 141. The photoelectric conversion circuit 223 is configured to transmit identified data to the circuit substrate 40 for the central processor for processing the identified data.

Referring to FIG. 4A, a small through hole 105 is set at the non reading and sensing area 1003 of the reading panel 100 and corresponds to the non information-sensing region 143 of the media 14. The second set of optoelectronic device 22B is placed in the reading panel 100 and the through window 225 at the second set of optoelectronic device 22B is adjacent to and communicates with the small through hole 105 at the reading panel 100, as seen in FIG. 4C.

### First Embodiment

### Tourism Newspaper

Referring to FIGS. 3A and 3B, a subject of a tourism newspaper is related to Great Wall of China. Electronic files related to the background, sound, pictures and video of Great Wall have been established. When the tourism newspaper is being read, the second set of optoelectronic device of the reading panel can read index data from the invisible codes on the non information-sensing region of the tourism newspaper alternatively printed with related information. The index data can be transmitted to the circuit substrate for the central processor for processing the index data. At the same time, positions related to Great Wall can be selected using the optoelectronic reading device. The optoelectronic reading device contains the first set of optoelectronic device that senses and reads coordinate data of the selected contents. The coordinate data can be transmitted to the circuit substrate for the central processor for processing the coordinate data.

Referring to FIG. 5D, the first and second sets of optoelectronic devices and the electronic coordinate circuit obtain processed data, that are, combined data of electronic files, respectively. Thereby, the related contents stored by the electronic files can be readily searched for and a reader can have a realistic experience of Great Wall and reflect the understanding of Great Wall.

### Second Embodiment

### Weekly Magazine

Referring to FIGS. 3C and 3D, when a weekly magazine is being read, the second set of optoelectronic device of the reading panel can read index data from the invisible codes on the non information-sensing region of a cover or bottom back page of the weekly magazine alternatively printed with related information. The index data can be transmitted to the circuit substrate for the central processor for processing the index data. At the same time, a catalog of the weekly magazine can be touch selected using the optoelectronic reading device such that the related contents stored by the electronic files of the catalog can be readily searched for and read.

For a confidential purpose, an electronic card reader has a contactless RF-induction card reading function at the non reading and sensing area of the reading panel. The media may have IC cards, containing a storage, at the non information-sensing regions thereof. The electronic card reader can read index data in a contactless way from the IC cards of the media. Accordingly, the present invention can be relatively widely used.

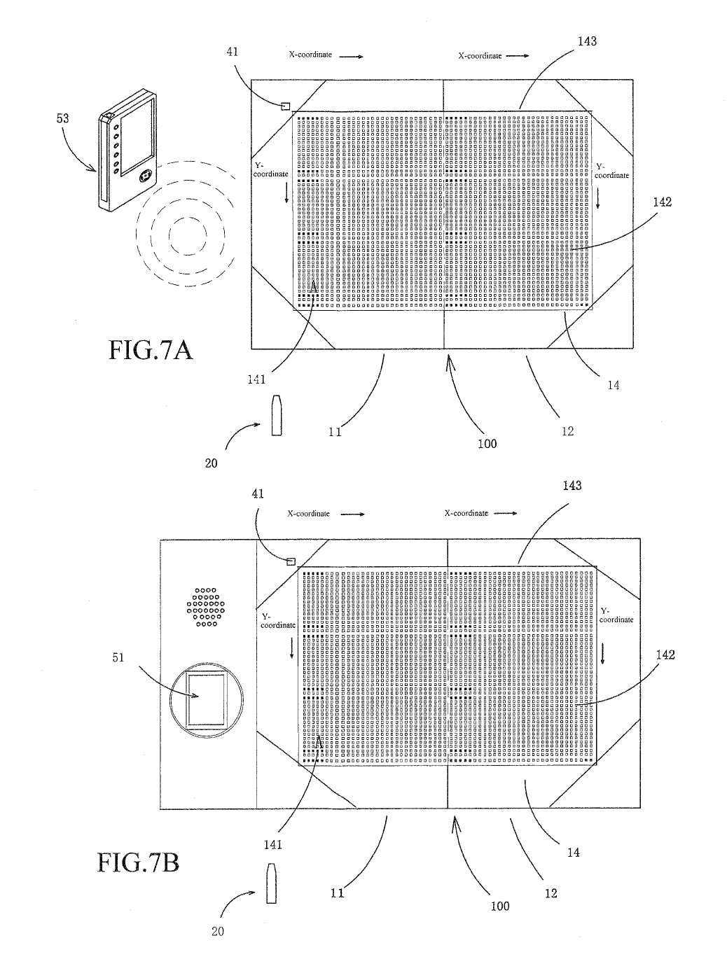

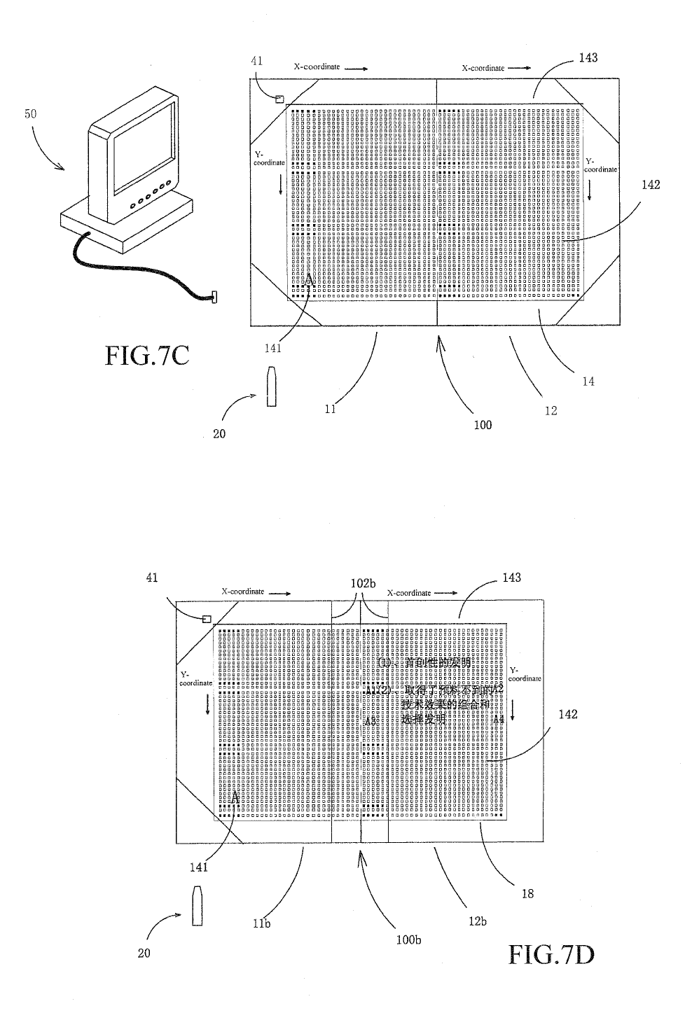

The reading panel 100 has a mechanism for fixing the media 14, as seen in FIGS. 7A-7D. The reading panel 100 has transparent positioning fixtures at four sides of the reading panel 100. The transparent positioning fixtures may have the media 14 smoothly placed on the reading panel 100. Thus, accuracy of determining a coordinate can be effectively enhanced.

An example is illustrated as below:

Referring to FIG. 7A, for wireless transmission of related data to an external wireless electronic reader 53, in the electronic card reader of the electronic reading device are a battery and a wireless transceiver circuit, and also in the optoelectronic reading device 20 are a battery and a wireless transceiver circuit.

Referring to FIG. 7B, in application of China patent application No. 200820001762.3, entitled as cover device having handheld computer or digital video mechanism pivotally joining therewith, a screen rotatable to any angle can be freely attached onto or detached from an electronic reader 51. Thereby, a browsing effect can be enhanced.

Referring to FIG. 7C, the electronic reading device can be provided with an external socket such that internal data thereof can be transmitted to an external electronic reader 50 through a wire. Accordingly, the electronic reading device can be used in combination with the electronic reader 50 connected to an external power supply.

Referring to FIG. 7D, when a reader read an intellectual-property newspapers, the second set of optoelectronic device of the reading panel can read index data, such as websites, from a back page of the intellectual-property newspapers. The contents in the second paragraph, which are in information-sensing regions A1, A2, A3 and A4, can be touch selected using the optoelectronic reading device according to reader's needs, and then transmitted to relevant circuits such that relevant reference oriented from the tough selected contents can be readily searched for.

In accordance with application of the present invention, when the blind read or touch braille words, interaction with listening can be combined. Under equivalent using conditions and effects, a braille-reading publication, compared to a traditional one, has a volume and weight that can be reduced up to more than 50% and thus is easy to be carried and used.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Furthermore, unless stated otherwise, the numerical ranges provided are intended to be inclusive of the stated lower and upper values. Moreover, unless stated otherwise, all material selections and numerical values are representative of preferred embodiments and other ranges and/or materials may be used.

The scope of protection is limited solely by the claims, and such scope is intended and should be interpreted to be as broad as is consistent with the ordinary meaning of the language that is used in the claims when interpreted in light of this specification and the prosecution history that follows, and to encompass all structural and functional equivalents thereof.

What is claimed is:

1. An electronic reading device having an on-paper window system and being capable of reading various data, wherein the electronic reading device comprises a reading panel and an electronic card reader, wherein the reading panel has a panel surface having media placed thereon, wherein the electronic card reader comprises an electronic coordinate device, a circuit substrate for a central processor, which is provided with a storage, and multiple sets of optoelectronic devices, wherein the electronic coordinate device comprises an electronic coordinate circuit and an electromagnetic-wave circuit configured to emit a signal with a fixed frequency, wherein a first set of optoelectronic device and the electromagnetic-wave circuit compose an optoelectronic reading device, wherein the optoelectronic reading device and a second set of optoelectronic device are configured to read various data from media, having information messages, and the electronic coordinate circuit, respectively, wherein the data is configured to be transmitted to the circuit substrate for the central processor and then processed into combined data of electronic files such that related information, based on the combined data, is configured to be readily searched for and read using a connected electronic reading product.

2. The electronic reading device of claim 1, wherein the reading panel, like a panel-shaped body, is divided into a reading and sensing area and non reading and sensing area, wherein the reading and sensing area corresponds to an effective sensing region of the electronic coordinate circuit in the reading panel, wherein the electronic coordinate circuit is arranged with multiple electronic antenna-array type of circuit substrates having multiple electronic antenna loops alternately formed and overlain with each other or one another, wherein the electronic antenna-array type of circuit substrates comprise a metal line, extending in a direction of X-axis, and another metal line, extending in a direction of Y-axis and across the direction of X-axis, that compose an array type of the antenna loops, wherein the antenna-array type of circuit substrates are configured to sense the signal with the fixed frequency emitted from the electromagnetic-wave circuit and have contacts electrically connected to an A/D device of the circuit substrate for the central processor.

3. The electronic reading device of claim 1, wherein the reading panel, like a panel-shaped body, comprises a left panel and a right panel configured to join with each other and move apart from a center line such that a clipping space is configured to be kept between the left and right panels, wherein the reading panel is divided into a reading and sensing area and a non reading and sensing area, wherein the reading and sensing area corresponds to an effective sensing region of the electronic coordinate circuit in the reading panel, wherein the left and right panels comprise electrically conductive devices, having opposite polarization, at neighboring sidewalls thereof and are electrically connected to the circuit substrate for the central processor, wherein the electronic coordinate circuit is arranged with multiple electronic antenna-array type of circuit substrates having multiple electronic antenna loops alternately formed and overlain with each other or one another, wherein the electronic antenna-array type of circuit substrates comprise a metal line, extending in a direction of X-axis, and another metal line, extending in a direction of Y-axis and across the direction of X-axis, that compose an array type of the antenna loops, wherein the antenna-array type of circuit substrates are configured to sense the signal with the fixed frequency emitted from the electromagnetic-wave circuit and have contacts electrically connected to an A/D device of the circuit substrate for the central processor.

4. The electronic reading device of claim 3, wherein each of the left and right panels comprises at least a magnetic block at a corresponding neighboring sidewall thereof, wherein the magnetic blocks of the left and right panels have opposite polarization.

5. The electronic reading device of claim 1, wherein the media are divided into an information-sensing region and a non information-sensing region corresponding to the reading and sensing area and non reading and sensing area of the reading panel, respectively.

6. The electronic reading device of claim 5, wherein the media are printed with invisible codes arranged with multiple minute symbol units printed using a fluorescent ink having optical response to an infrared ray from an infrared emitter, wherein the media having different information-sensing regions are not printed with the same invisible code.

7. The electronic reading device of claim 5, wherein the non information-sensing region of the media is printed with an invisible code, wherein the invisible code is arranged with multiple minute symbol units and is printed using a fluorescent ink having optical response to an infrared ray from an infrared emitter.

8. The electronic reading device of claim 1, wherein the first set of optoelectronic device comprises an infrared emitter, an image capturing device and a photoelectric conversion circuit, wherein the image capturing device is configured to capture a response image of an invisible code, and the photoelectric conversion circuit is configured to transmit identified data to the circuit substrate for the central processor for processing the identified data, wherein the optoelectronic reading device comprises a functional switch and an output circuit.

9. The electronic reading device of claim 1, wherein the second set of optoelectronic device comprises an infrared emitter, an image capturing device and a photoelectric conversion circuit and is placed in an internally hollow body, wherein a through window is set at a front end of the internally hollow body, wherein the infrared emitter is configured to emit an infrared ray to the outside via the through window, and the image capturing device is configured to capture an image via the through window, wherein the image capturing device is configured to capture a response image of an invisible code, wherein the photoelectric conversion circuit is configured to transmit identified data to the circuit substrate for the central processor for processing the identified data.

10. The electronic reading device of claim 1, wherein a small through hole is set at the non reading and sensing area of the reading panel and corresponds to the non information-sensing region of the media, wherein the second set of optoelectronic device is placed in the reading panel and the through window at the second set of optoelectronic device is adjacent to and communicates with the small through hole at the reading panel.
